(19) United States
(12) Patent Application Publication
(10) Pub. No.: US 2015/0162715 A1
(43) Pub. Date: Jun. 11, 2015

(54) LOCKING STRUCTURE OF TERMINAL FITTING, BULB SOCKET, AND ILLUMINATION DEVICE

(71) Applicant: YAZAKI CORPORATION, Tokyo (JP)

(72) Inventors: Hideki YAMANAKA, Makinohara-shi (JP); Shinji YAMADA, Yokohama-shi (JP); Hirohito TORIYAMA, Yokohama-shi (JP)

(73) Assignee: YAZAKI CORPORATION, Tokyo (JP)

(21) Appl. No.: 14/564,630

(22) Filed: Dec. 9, 2014

(30) Foreign Application Priority Data
Dec. 11, 2013 (JP) 2013-255865

(51) Int. Cl. H01R 33/09

(52) U.S. Cl. CPC H01R 33/09

(57) ABSTRACT

A locking structure of a terminal fitting includes a terminal fitting, a terminal containing portion that holds and contains the terminal fitting, and a restriction member that is separate from and is attached to the terminal containing portion. A lock projection of the terminal fitting is locked on a holding-side lock portion of the terminal containing portion at a lock position of the holding-side lock portion. The holding-side lock portion is provided so as to be deformed elastically in such a direction as to reduce an elastic deformation amount of the lock projection being moved toward the lock position for the elastic restoration. The restriction member has a restriction wall which restricts elastic deformation of the holding-side lock portion in an unlocking direction in which the lock with the lock projection is released.

### BACKGROUND

The present disclosure relates to a locking structure of a terminal fitting in which a lock projection of the terminal fitting is locked on a holding-side lock portion as a result of elastic recovery (elastic restoration) of the lock projection at a lock position, a bulb socket having the lock structure, and an illumination device having the bulb socket.

Among related locking structures of a terminal fitting in which a terminal fitting is held by and contained in a terminal containing portion of a connector, a bulb socket, or the like is one in which a lock projection of a terminal fitting is locked on a holding-side lock portion of a terminal containing portion as a result of elastic recovery of the lock projection at a lock position of the holding-side lock portion.

For example, JP-A-2013-152898 discloses a bulb socket in which a terminal fitting is held by and contained in a terminal containing portion provided in a socket main body by locking, in the terminal containing portion, a lock piece (lock projection) formed by cutting and erecting a portion of the terminal fitting.

However, the locking structure of a terminal fitting disclosed in JP-A-2013-152898 has the following problem. The lock piece (lock projection) is locked on a projection (holding-side lock portion) provided in the terminal containing portion. Therefore, as the lock piece is moved toward a lock position, it needs to be deformed to a large extent in the direction opposite to its projection direction to climb over the projection (holding-side lock portion). As a result, its resilience that is necessary for recovery in the projection direction may be decreased, possibly resulting in lowering of the locking force.

### SUMMARY

The present disclosure has been made in the above circumstances, and an object of the present disclosure is therefore to provide a locking structure of a terminal fitting which can prevent lowering of the force for locking of the terminal fitting, a bulb socket having the lock structure, and an illumination device having the bulb socket.

To solve the above problem and attain the above object, the present disclosure provides a locking structure of a terminal fitting, comprising:

a terminal fitting;

a terminal containing portion that holds and contains the terminal fitting; and

a restriction member that is separate from and is attached to the terminal containing portion,

wherein a lock projection of the terminal fitting is locked on a holding-side lock portion of the terminal containing portion as a result of elastic restoration of the lock projection at a lock position of the holding-side lock portion;

wherein the holding-side lock portion is provided so as to be deformed elastically in such a direction as to reduce an elastic deformation amount of the lock projection being moved toward the lock position for the elastic restoration; and

wherein the restriction member has a restriction wall which restricts elastic deformation of the holding-side lock portion in an unlocking direction in which the lock with the lock projection is released.

According to the above configuration, the locking structure can prevent reduction of the resilience of the lock projection by decreasing its elastic deformation amount and also can produce a strong locking force because the restriction member restricts elastic deformation of the holding-side lock portion in the unlocking direction. As a result, lowering of the force for locking of the terminal fitting can be prevented.

According to the present disclosure, there is also provided a bulb socket for supplying power to a bulb as a light source, comprising:

the locking structure of the terminal fitting described in the above,

wherein the terminal fitting has a terminal portion which is connected to the bulb; and

wherein the terminal containing portion is provided in a socket main body of the bulb socket.

By the above configuration, since the bulb socket incorporates the locking structure of a terminal fitting recited in the above, when the terminal containing portion of the socket main body which is provided in the socket main body holds and contains the terminal fitting, reduction of the resilience of the lock projection can be prevented by decreasing its elastic deformation amount. Furthermore, a strong locking force can be produced because the restriction member restricts elastic deformation of the holding-side lock portion in the unlocking direction. As a result, lowering of the force for locking of the terminal fitting can be prevented.

According to the present disclosure, there is also provided an illumination device comprising:

a bulb as a light source;

a translucent lens for transmitting, to outside the illumination device, light emitted from the bulb;

a light leakage prevention cover that prevents leakage of light through a portion other than the translucent lens; and

the bulb socket described in the above.

By the above configuration, since the illumination device incorporates the bulb socket recited in the above, lowering of the force for locking of the terminal fitting can be prevented as in the bulb socket recited in the above.

For example, the socket main body has a cover lock portion which is locked on the light leakage prevention cover, the light leakage prevention cover has a lock counterpart portion on which the cover lock portion is locked so as to be supported by the cover lock portion, and the restriction member is attached to the terminal containing portion so that an inner wall surface of the cover lock portion is located outside the restriction wall in the unlocking direction of the holding-side lock portion.

By the above configuration, the restriction member is located between the holding-side lock portion and the cover lock portion in the unlocking direction of the holding-side lock portion and restricts elastic deformation of the holding-side lock portion in the unlocking direction. Furthermore, the inner wall surface of the holding-side lock portion which is made stronger as a result of its locking on the lock counterpart portion of the light leakage prevention cover prevents bending or positional deviation of the restriction wall. As a result, the force for locking of the terminal fitting can be increased further.

For example, the restriction member is integrally formed on the light leakage prevention cover.

By the above configuration, the number of components can be reduced, as a result of which assembling work can be facilitated.

### BRIEF DESCRIPTION OF THE DRAWINGS

The above objects and advantages of the present disclosure will become more apparent by describing in detail preferred exemplary embodiments thereof with reference to the accompanying drawings, wherein:

FIG. 1 is an exploded perspective view of an illumination device according to a first embodiment of the present disclosure;

FIG. 2A is a perspective view of the illumination device as viewed from the side of a translucent lens, and FIG. 2B is a perspective view of the illumination device as viewed from the side of a light leakage prevention cover;

FIG. 3 is a perspective view, as viewed from the side of the light leakage prevention cover, of the illumination device to which the translucent lens has not been attached yet; FIG. 4 is a front view, as viewed from the side of the light leakage prevention cover, of the illumination device in the same state as shown in FIG. 3;

FIG. 5A is a sectional view of the illumination device taken along line A-A in FIG. 4, and FIG. 5B is an enlarged view of part of FIG. 5A, that is, a restriction wall and its neighborhood;

FIG. 6 is a view of the illumination device as view from the direction indicated by arrow A′ in FIG. 4;

FIG. 7A is a sectional view of the illumination device taken along line B-B in FIG. 6, and FIG. 7B is an enlarged view of part of FIG. 7A, that is, a restriction wall and its neighborhood;

FIG. 8 is a front view of a socket main body as viewed from the side of an opening of an insertion hole;

FIG. 9A is a sectional view of the socket main body taken along line C-C in FIG. 8, and FIG. 9B is an enlarged view of part of FIG. 9A, that is, a holding-side lock portion and its neighborhood;

FIG. 10 is a perspective view of the socket main body;

FIG. 11 is an enlarged view, as viewed from the side of the opening of the insertion hole, of part of the socket main body to which terminal fittings are attached;

FIG. 12 is a perspective view of one of the terminal fittings;

FIG. 13A is a sectional view of the pair of terminal fittings, and FIG. 13B is an enlarged view of part of FIG. 13A, that is, a lock projection and its neighborhood;

FIG. 14 shows a state before insertion of the pair of terminal fittings into respective terminal containing portions of the socket main body;

FIG. 15A shows a state immediately before the pair of terminal fittings reach the lock positions of the holding-side lock portions, and FIG. 15B is an enlarged view of part of FIG. 15A, that is, one holding-side lock portion and its neighborhood;

FIG. 16A shows a state that the lock projections are locked on the respective holding-side lock portions, and FIG. 16B is an enlarged view of part of FIG. 16A, that is, one holding-side lock portion and its neighborhood;

FIG. 17 shows a state before attachment of a restriction member to the socket main body;

FIG. 18A shows a state that the restriction member is attached to the terminal containing portions, and FIG. 18B is an enlarged view of part of FIG. 18A, that is, one restriction wall and its neighborhood;

FIG. 19A shows a state before attachment of the light leakage prevention cover and a bulb to the socket main body, and FIG. 19B shows a state that the light leakage prevention cover and the bulb are attached to the socket main body;

FIG. 20 is an exploded perspective view of an illumination device according to a second embodiment of the present disclosure;

FIG. 21A is a front view, as viewed from the side of a light leakage prevention cover, of the illumination device shown in FIG. 20 to which a translucent lens has not been attached yet, and FIG. 21B is a view of the illumination device as view from the direction indicated by arrow B in FIG. 21A;

FIG. 22A is a sectional view of the illumination device taken along line D-D in FIG. 21A, and FIG. 22B is an enlarged view of part of FIG. 22A, that is, a restriction wall and its neighborhood;

FIG. 23A is a sectional view of the illumination device taken along line E-E in FIG. 21B, and FIG. 23B is an enlarged view of part of FIG. 23A, that is, a restriction wall and its neighborhood; and

FIG. 24A is a top view of the light leakage prevention cover shown in FIG. 20, and FIG. 24B is a sectional view of the light leakage prevention cover taken along line F-F in FIG. 24A.

### DETAILED DESCRIPTION OF EXEMPLARY EMBODIMENTS

Locking structures of terminal fittings, bulb sockets, and illumination devices according to preferred embodiments of the present disclosure will be hereinafter described in detail with reference to the drawings.

### Embodiment 1

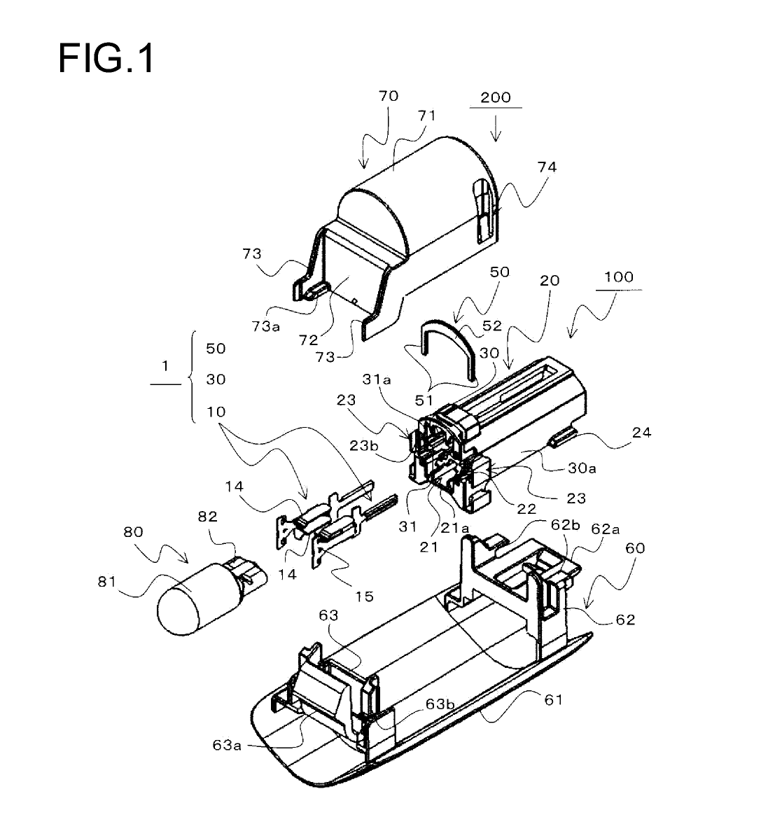

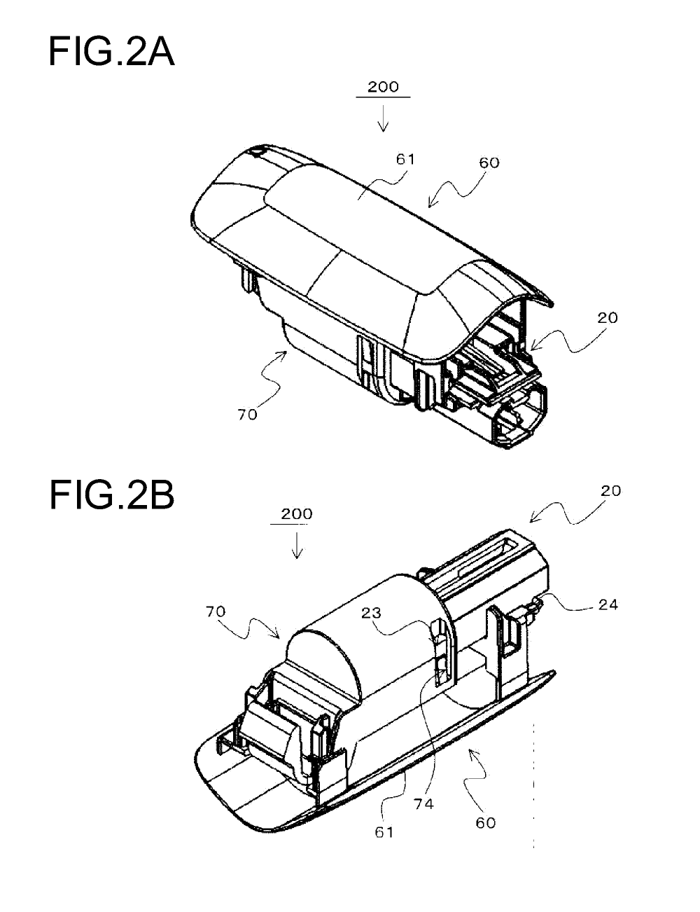

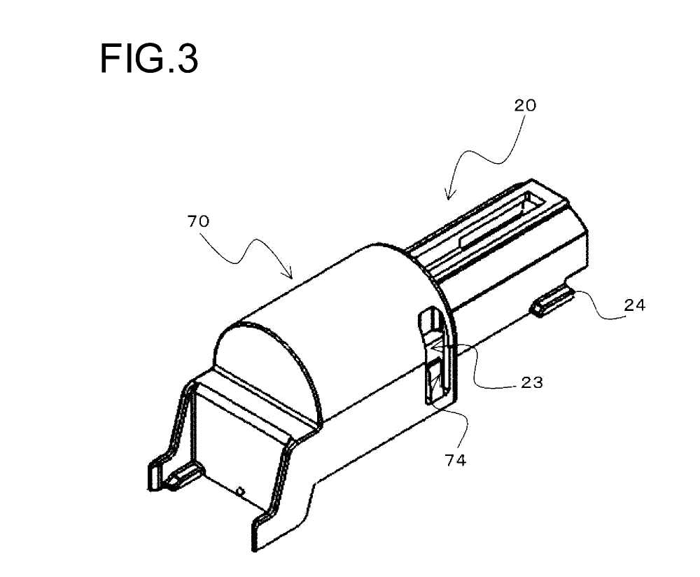

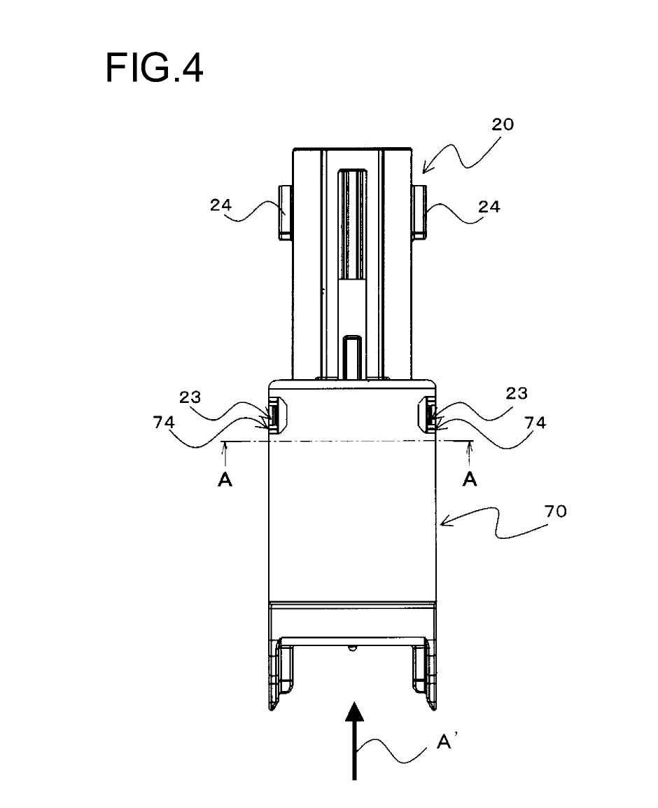

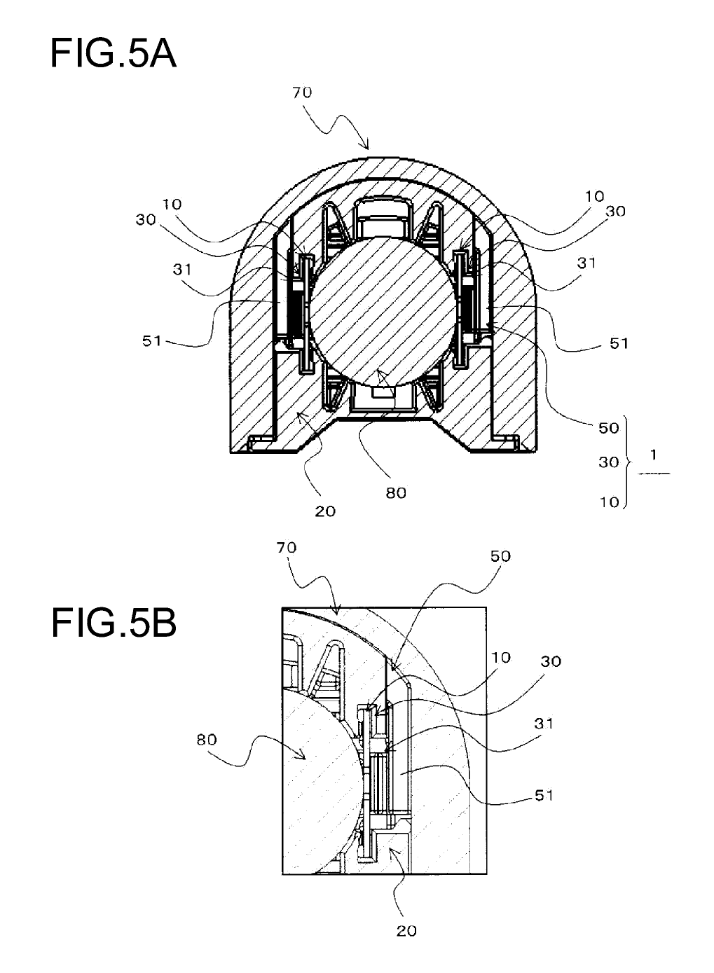

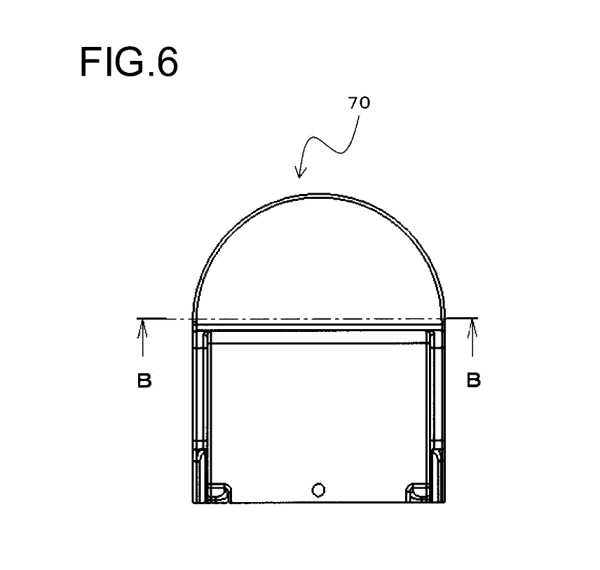

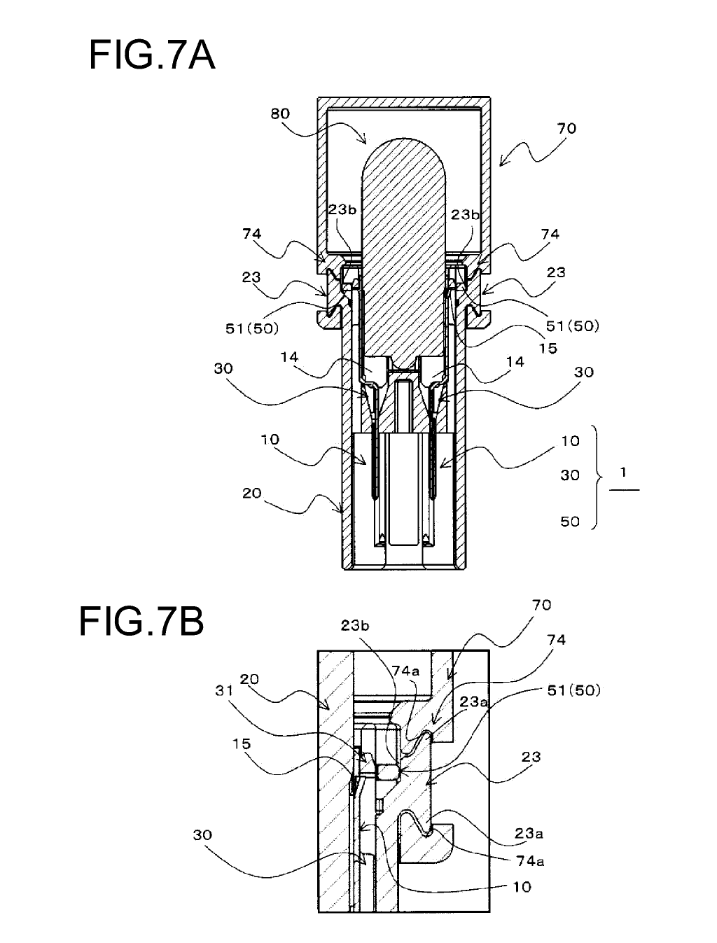

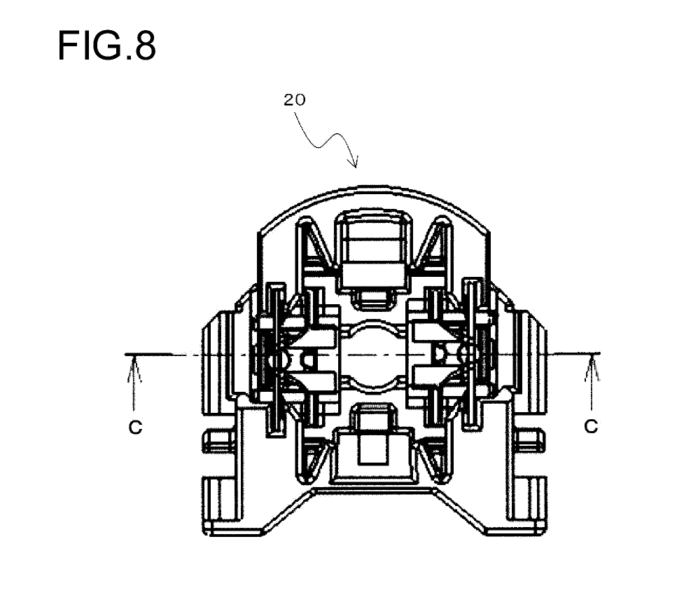

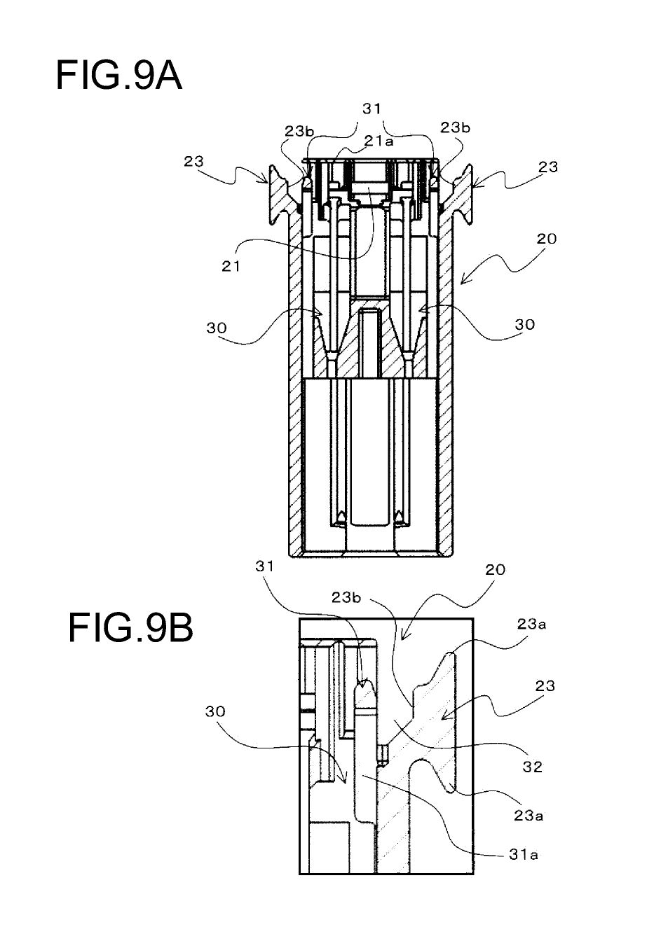

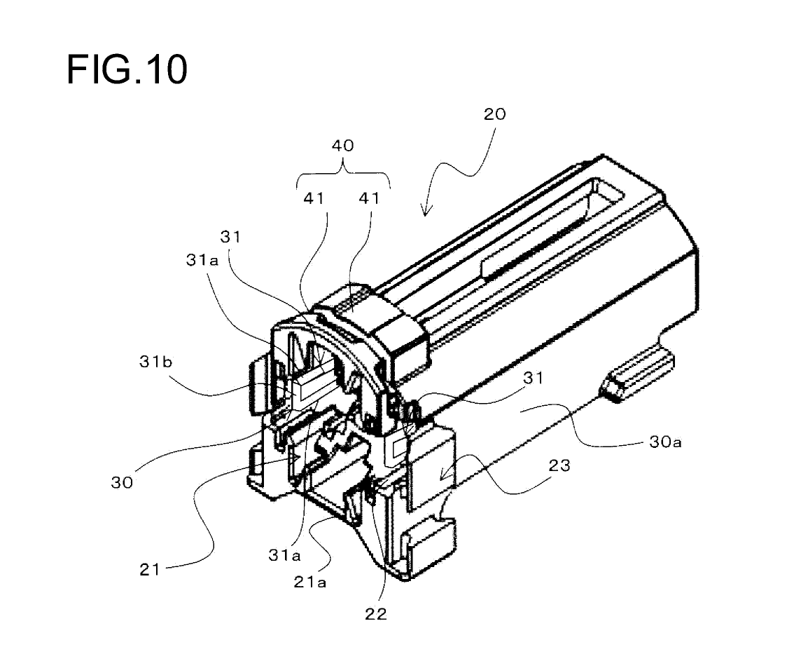

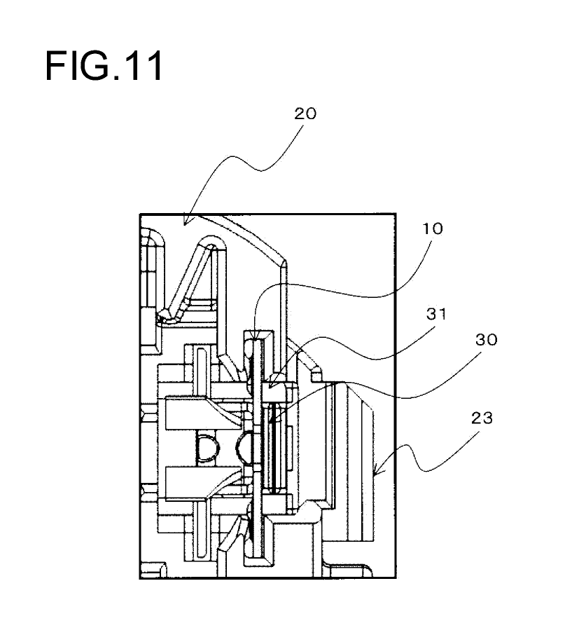

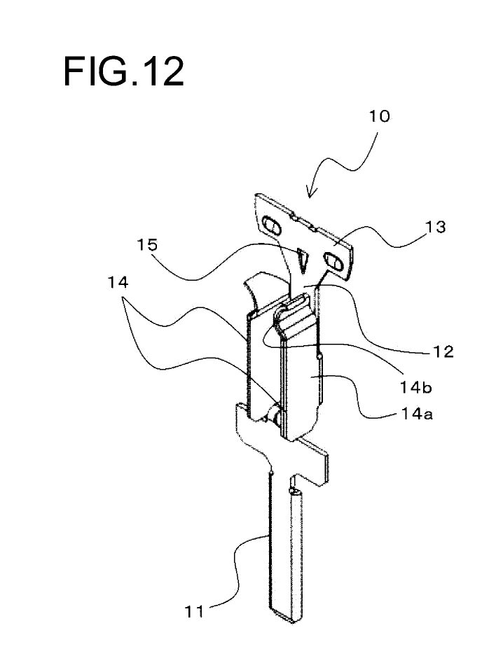

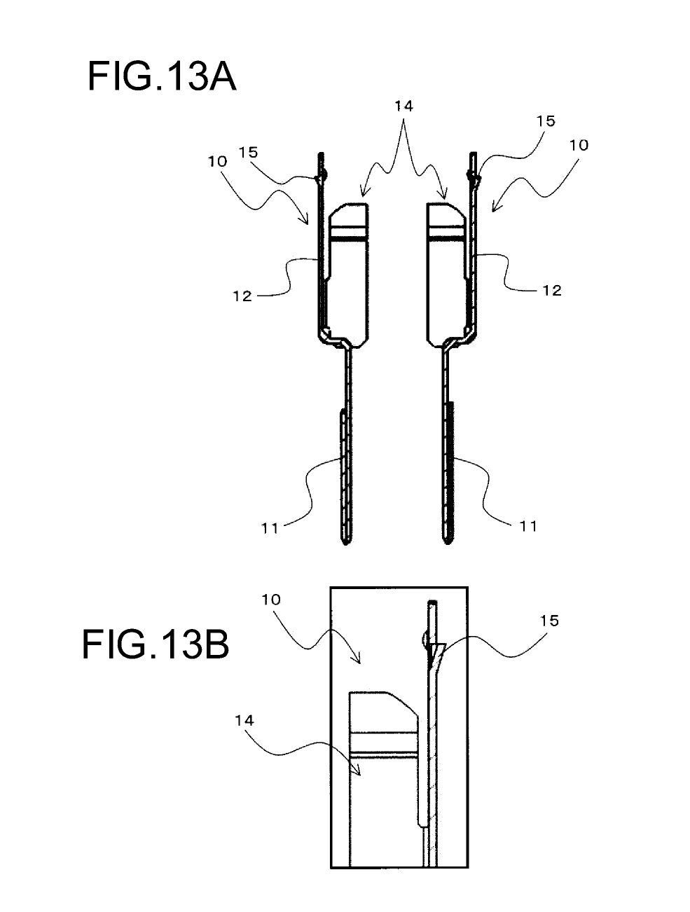

FIG. 1 is an exploded perspective view of an illumination device 200 according to a first embodiment of the present disclosure. FIG. 2A is a perspective view of the illumination device 200 as viewed from the side of a translucent lens 60, and FIG. 2B is a perspective view of the illumination device 200 as viewed from the side of a light leakage prevention cover 70. FIG. 3 is a perspective view, as viewed from the side of the light leakage prevention cover 70, of the illumination device 200 to which the translucent lens 60 has not been attached yet. FIG. 4 is a front view, as viewed from the side of the light leakage prevention cover 70, of the illumination device 200 in the same state as shown in FIG. 3. FIG. 5A is a sectional view of the illumination device 200 taken along line A-A in FIG. 4, and FIG. 5B is an enlarged view of part of FIG. 5A, that is, a restriction wall 51 and its neighborhood. FIG. 6 is a view of the illumination device 200 as view from the direction indicated by arrow A′ in FIG. 4. FIG. 7A is a sectional view of the illumination device 200 taken along line B-B in FIG. 6, and FIG. 7B is an enlarged view of part of FIG. 7A, that is, a restriction wall 51 and its neighborhood. FIG. 8 is a front view of a socket main body 20 as viewed from the side of an opening 21a of an insertion hole 21. FIG. 9A is a sectional view of the socket main body 20 taken along line C-C in FIG. 8, and FIG. 9B is an enlarged view of part of FIG. 9A, that is, a holding-side lock portion 31 and its neighborhood. FIG. 10 is a perspective view of the socket main body 20. FIG. 11 is an enlarged view, as viewed from the side of the opening 21a of the insertion hole 21, of part of the socket main body 20 to which terminal fittings 10 are attached. FIG. 12 is a perspective view of one of the terminal fittings 10. FIG. 13A is a sectional view of the pair of terminal fittings 10, and FIG. 13B is an enlarged view of part of FIG. 13A, that is, a lock projection 15 and its neighborhood.

For example, the illumination device 200 according to the first embodiment of the present disclosure is a room illumination device that is installed in an automobile or the like. The illumination device 200 is equipped with a bulb 80 which is a light source, a bulb socket 100, the translucent lens 60 for transmitting, to outside the device, light emitted from the bulb 80, and the light leakage prevention cover 70 for preventing leakage of light through portions other than the translucent lens 60.

First, the bulb 80 will be described. As shown in FIG. 1, the bulb 80, which is what is called a wedge base bulb, is equipped with a light emitting unit 81 in which a filament (not shown) is disposed inside a cylindrical glass member and an electrode unit 82 which is provided with a pair of terminals (not shown), that is, an anode terminal and a cathode terminal.

Next, the bulb socket 100 will be described. The bulb socket 100, which incorporates a locking structure 1 of terminal fittings, serves to supply power to the bulb 80.

The locking structure 1 of terminal fittings is equipped with a pair of metal fittings 10 which are connected to the bulb 80, two terminal containing portions 30 which hold and contain the respective terminal fittings 10, and a restriction member 50. The two terminal containing portions 30 are provided in the socket main body 20 which is the main body of the bulb socket 100.

The pair of metal fittings 10, which are what is called bus bars, are formed by punching a conductive metal plate and bending punched-out members. As shown in FIG. 13A, the pair of metal fittings 10 are attached to the respective terminal containing portions 30 so as to be opposed to each other in a left-right symmetrical manner.

Each terminal fitting 10 has a fixing portion 11 which is disposed inside and fixed to the terminal containing portion 30 and is to be connected to a cable (not shown), an extension portion 12 which extends from the fixing portion 11, width portions 13 which project from the respective sides of a tip portion of the extension portion 12 so as to increase the width, a pair of terminal portions 14 which are bent from respective portions of the side edges of the extension portion 12 and are parallel with each other, and a lock projection 15 which is formed by cutting and erecting a portion of the extension portion 12 so as to assume a nail-like shape.

The fixing portion 11 assumes a plate-like shape and extends in the top-bottom direction in FIG. 12 (longitudinal direction). The fixing portion 11 is disposed at a deep position inside the terminal containing portion 30.

The extension portion 12 is bent from the fixing portion 11 and then bent again so as to extend parallel with the fixing portion 11 toward the opening 21a of the insertion hole 21 (a crank shape is formed).

The width portions 13 project perpendicularly from the two respective sides of the tip portion of the extension portion 12, and the width portions 13 and the extension portion 12 assume a T shape together.

Each of the pair of terminal portions 14 has a spring portion 14a which is bent from a side portion of the extension portion 12 (i.e., supported on one side) and extends toward the opening 21a of the insertion hole 21 and a contact portion 14b which is formed by bending a tip portion of the spring portion 14a so as to have a certain curved surface.

Having the above structure, the pair of terminal portions 14 nip the electrode unit 82 of the bulb 80 which is inserted in the insertion hole 21 and are thereby electrically connected to the electrode (not shown) provided in the electrode unit 82.

Next, the socket main body 20 will be described. The socket main body 20 is the main body of the bulb socket 100. The socket main body 20 is made of an insulating material such as a synthetic resin and generally assumes a cylindrical shape. Cables (not shown) are wired inside the socket main body 20 through the light leakage prevention cover 70 and connected to the respective terminal fittings 10, whereby power is supplied to the bulb 80.

The socket main body 20 has the insertion hole 21 which receives the electrode unit 82 of the bulb 80, the pair of terminal containing portions 30 which form spaces that are continuous with the insertion hole 21 and thereby hold and contain the respective terminal fittings 10, a restriction member holding portion 40 which holds the restriction member 50, cover lock portions 23 which are locked on the light leakage prevention cover 70, and lens engagement portions 24 which are engaged with the translucent lens 60.

Each terminal containing portion 30 has a holding-side lock portion 31 on which the lock projection 15 of the terminal fitting 10 is locked as a result of elastic recovery of the lock projection 15 at the lock position in the terminal containing portion 30.

Each holding-side lock portion 31 is formed so as to be able to be deformed elastically in such a direction as to reduce the elastic deformation amount of the lock projection 15 being moved toward the lock position. That is, each holding-side lock portion 31 has such a structure as to be able to bend toward the outside of the socket main body 20. More specifically, each holding-side lock portion 31 has a pair of elastic arms 31a each of which projects from and supported on one side by an inner wall (which defines an housing space) of the terminal containing portion 30 toward the opening 21a of the insertion hole 21 and a link portion 31b which connected respective tip portions of the elastic arms 31a.

As shown in FIG. 9B, a gap space 32 into which the restriction wall 51 of the restriction member 50 can be inserted is formed between the cover engagement portion 23 and the pair of elastic arms 31a. The gap space 32 is formed in such a manner that a cut 22 is formed in a wall 30a of the terminal containing portion 30 so as to extend inward from the opening 21a of the insertion hole 21 so as to expose portions of the respective elastic arms 31a and the cover lock portion 23 is formed so as to project toward the end of the socket main body 20 so as to cover the cut 22.

With this structure, before the restriction member 50 is attached to the socket main body 20, that is, the terminal containing portions 30, the pair of elastic arms 31a can bend to the outside of the socket main body 20, that is, into the gap space 32. That is, as the lock projection 15 is moved toward the lock position, the pair of elastic arms 31a can bend outward so as to reduce the elastic deformation amount of the lock projection 15.

The restriction member holding portion 40 serves to hold the restriction member 50. The restriction member holding portion 40 is composed of a pair of confronting walls 41 (see FIG. 10) for holding the restriction member 50 in place when a link portion 52 (described later) of the restriction member 50 is inserted between them. The pair of confronting walls 41 are erected from the top surface of an end portion, adjacent to the opening 21a of the insertion hole 21, of the socket main body 20 so as to be opposed to each other. When the link portion 52 is placed between the pair of confronting walls 41, each restriction wall 51 comes to be located between the cover lock portion 23 and the pair of elastic arms 31a.

The cover lock portions 23 are formed on two side portions, adjacent to the cuts 22, of the socket main body 20 so as to cover the cuts 22 from outside, respectively. Each cover lock portion 23 has a pair of projected guide flanges 23a which extend straightly in the direction in which the light leakage prevention cover 70 is slid when it is attached to the socket main body 20. The pair of projected guide flanges 23a are locked on a corresponding lock counterpart portion 74 (described later) of the light leakage prevention cover 70 when the pair of projected guide flanges 23a are slid relative to and fitted into respective guide grooves 74a of the lock counterpart portion 74.

Next, the restriction member 50 will be described. The restriction member 50 has the restriction walls 51 which restrict elastic deformation of the respective holding-side lock portions 31 in the unlocking directions. The restriction member 50 is a member that is separate from the terminal containing portions 30 and is attached to the terminal containing portions 30.

The restriction member 50 is made of an insulating material such as a synthetic resin, and is generally shaped like a gate (U-shape) so as to be able to be attached to the socket main body 20 so as to extend along the top surface and the side surfaces of an end portion of the socket main body 20. The restriction member 50 is composed of the pair of restriction walls 51 and the link portion 52 which connects the tops of the pair of restriction walls 51. The width of the restriction walls 51 is set slightly smaller than that of each gap space 32 between the cover lock portion 23 and the pair of elastic arms 31a.

The restriction member 50 having the above structure is attached to the terminal containing portions 30 in such a manner that the restriction walls 51 are placed outside the holding-side lock portions 31 and inside wall surfaces 23b of the cover lock portions 23 in the locking/unlocking directions of the holding-side lock portions 31. That is, the restriction member 50 is attached to the terminal containing portions 30 so that each restriction wall 50 is placed between the cover lock portion 23 and the pair of elastic arms 31a.

Therefore, when the holding-side lock portions 31 are deformed elastically in the unlocking directions, the holding-side lock portions 31 come into contact with the respective restriction walls 51. Thus, the restriction member 50 can restrict elastic deformation of the holding-side lock portions 31 in the unlocking directions and thereby allows the lock projections 15 to be locked on the respective holding-side lock portions 31 with strong locking forces.

Since the restriction member 50 allows the lock projections 15 to be locked on the respective holding-side lock portions 31 with strong locking forces, the holding-side lock portions 31 can be formed so as to be more apt to be elastically deformed in the unlocking direction, that is, the elastic arms 31a can be made thinner.

The translucent lens 60 is made of a light transparent resin material, and is composed of a lens main body 61 which is shaped like a curved plate and a first attachment portion 62 and a second attachment portion 63 which project from the inner surface of the lens main body 61.

The first attachment portion 62 has a lock piece 62a which projects outward parallel with an end portion, opposite to the opening 21a of the insertion hole 21, of the socket main body 20 and a pair of first engagement portions 62b which can be engaged with respective lens engagement portions 24 of the socket main body 20. The second attachment portion 63 has a lock portion 63a which can be engaged with an interior member (not shown) of a vehicle and a pair of second engagement portions 63b which can be engaged with respective lens engagement portions 73a of the light leakage prevention cover 70.

The light leakage prevention cover 70 is made of an insulating material such as a synthetic resin, and is composed of a cover main body 71 which is generally shaped like a semicylinder, an end wall 72 which is continuous with one end portion of the cover main body 71 and covers the light emitting unit 81 of the bulb 80 that is attached to the socket main body 20, and a pair of flanges 73 which project from the sides of the end wall 72.

The inner surface of the cover main body 71 is formed with a reflection surface (not shown) for reflecting, toward the translucent lens 60, light emitted from the light emitting unit 81 so that light can be radiated outward efficiently from the translucent lens 60.

The cover main body 71 is also formed with the pair of lock counterpart portions 74 on which the respective cover lock portions 23 of the socket main body 20 are locked. Each lock counterpart portion 74 has the pair of guide grooves 74a which are fitted with the respective projected guide flanges 23a of the corresponding cover lock portion 23. The light leakage prevention cover 70 is pressed downward (as viewed in FIG. 1) against the socket main body 20, whereby the guide grooves 74a come to be fitted with the respective projected guide flanges 23a.

Since the cover lock portions 23 are locked on the respective lock counterpart portions 74 in the above manner, each lock counterpart portion 74 is placed so as to cover the two side portions of the corresponding cover lock portion 23. That is, the cover lock portions 23 are locked on the respective lock counterpart portions 74 in such a manner that the latter support the former.

The inner wall surfaces 23b of the cover lock portions 23 which are made stronger as a result of their locking on the respective lock counterpart portions 74 of the light leakage prevention cover 70 prevent bending or positional deviation of the restriction walls 51. As a result, the lock projections 15 can be locked on the respective holding-side lock portions 31 with stronger locking forces.

The flanges 73 have the respective lens engagement portions 73a which are engaged with the translucent lens 60. The lens engagement portions 73a are slid to be engaged with the respective second engagement portions 63b of the translucent lens 60.

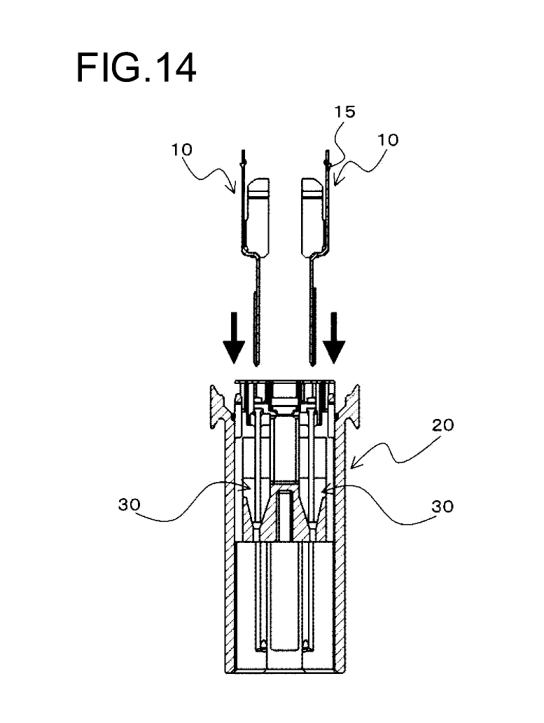

Next, an assembling procedure of the illumination device 200 according to the first embodiment of the present disclosure and how the individual portions work during that course will be described with reference to FIG. 14 to FIGS. 19A and 19B.

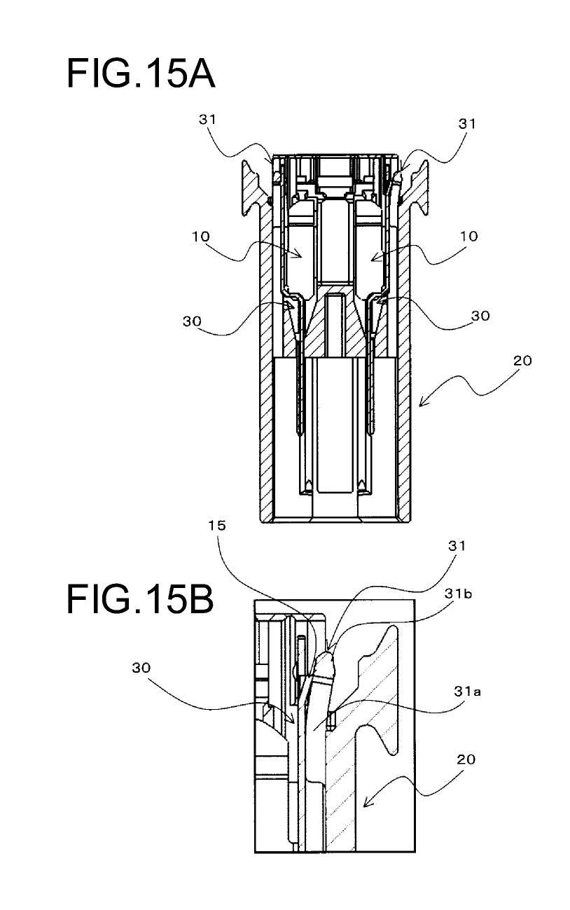

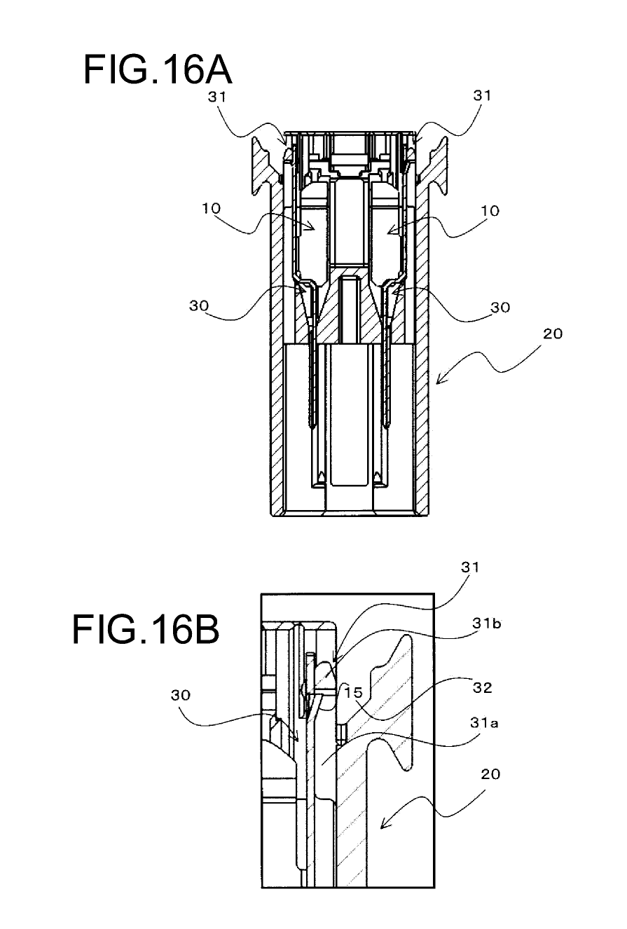

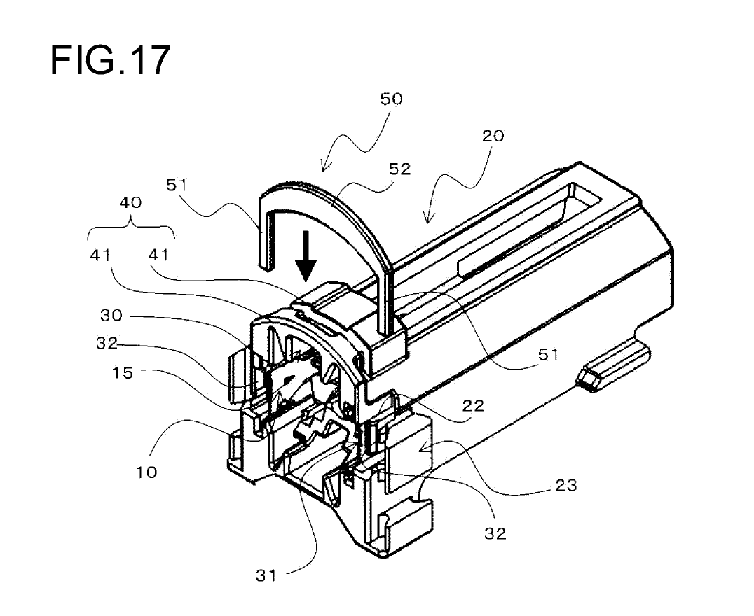

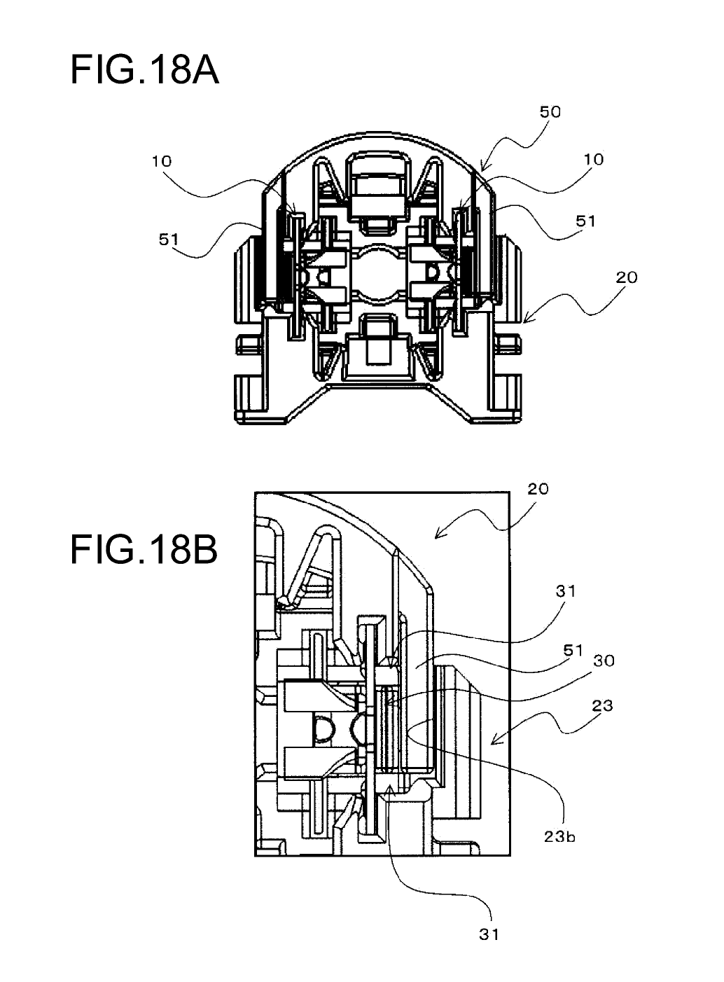

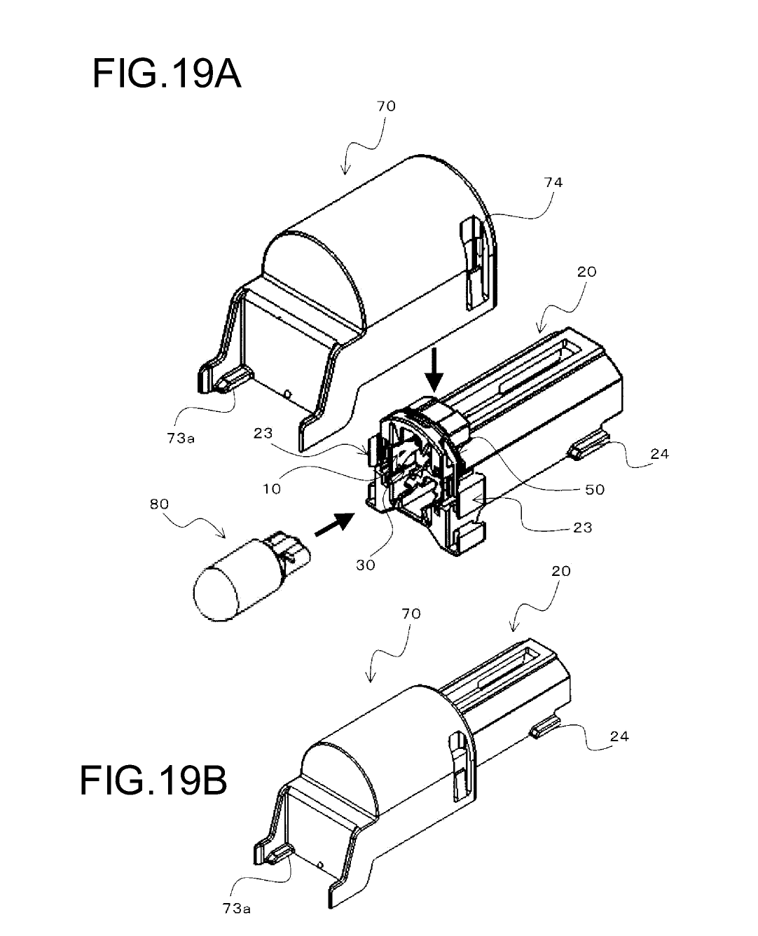

FIG. 14 shows a state before insertion of the pair of terminal fittings 10 into the respective terminal containing portions 30. FIG. 15A shows a state immediately before the pair of terminal fittings 10 reach the lock positions of the holding-side lock portions 31, and FIG. 15B is an enlarged view of part of FIG. 15A, that is, one holding-side lock portion 31 and its neighborhood. FIG. 16A shows a state that the lock projections 15 are locked on the respective holding-side lock portions 31, and FIG. 16B is an enlarged view of part of FIG. 16A, that is, one holding-side lock portion 31 and its neighborhood. FIG. 17 shows a state before attachment of the restriction member 50 to the socket main body 20. FIG. 18A shows a state that the restriction member 50 is attached to the socket main body 20 and FIG. 18B is an enlarged view of part of FIG. 18A, that is, one restriction wall 51 and its neighborhood. FIG. 19A shows a state before attachment of the light leakage prevention cover 70 and the bulb 80 to the socket main body 20, and FIG. 19B shows a state that the light leakage prevention cover 70 and the bulb 80 are attached to the socket main body 20.

First, the worker inserts the pair of terminal fittings 10 into the respective terminal containing portions 30 of the socket main body 20 (see FIG. 14 to FIGS. 16A and 16B).

As the terminal fittings 10 are inserted (before they reach the lock positions), as shown in FIGS. 15A and 15B the pair of elastic arms 31a of each holding-side lock portion 31 are bent outward into the gap space 32 into which the restriction wall 51 is to be inserted later. Therefore, the terminal fittings 10 can move to the lock positions while the elastic deformation amounts of the lock projections 15 are kept small.

Once the lock projections 15 have reached the lock positions, that is, they have climbed over the link portion 31b of the holding-side lock portions 31, each pair of elastic arms 31a recover elastically and the lock projections 15 are locked on the respective holding-side lock portions 31.

In the state that the lock projections 15 are locked on the respective holding-side lock portions 31, each pair of elastic arms 31a are prone to be deformed outward, that is, the lock projections 15 are prone to be unlocked from the respective holding-side lock portions 31.

Then the worker attaches the restriction member 50 to the terminal containing portions 30 (see FIG. 17 and FIGS. 18A and 18B). That is, as shown in FIG. 17, the worker pushes the link portion 52 of the restriction member 50 into the space between the pair of confronting walls 41 of the restriction member holding portion 40 from above the socket main body 20.

As a result, each restriction wall 51 is placed in the gap space 32 between the cover lock portion 23 and the elastic arms 31a and thereby restricts outward bending of the elastic arms 31a of the holding-side lock portion 31.

Subsequently, as shown in FIGS. 19A and 19B, the worker attaches the bulb 80 to the socket main body 20. And the worker attaches the light leakage prevention cover 70 to the socket main body 20. This is done by locking the pair of cover lock portions 23 of the socket main body 20 on the respective lock counterpart portions 74 of the light leakage prevention cover 70. As a result, the two side portions of each cover lock portion 23 are supported by the corresponding lock counterpart portion 74.

Finally, the worker attaches the translucent lens 60 to the assembly of the bulb socket 100 and the light leakage prevention cover 70. More specifically, the worker slides the assembly of the bulb socket 100 and the light leakage prevention cover 70 with respect to the translucent lens 60, whereby the pair of lens engagement portions 73a of the light leakage prevention cover 70 are engaged with the respective second engagement portions 63b of the translucent lens 60 and the pair of first lens engagement portions 24 of the socket main body 20 are engaged with the respective first engagement portions 62b of the translucent lens 60.

According to the locking structure 1 of terminal fittings according to the first embodiment of the present disclosure, since the elastic deformation amounts of the lock projections 15 are reduced, lowering of their resilience can be prevented. Furthermore, since the restriction member 50 restricts elastic deformation of the holding-side lock portions 31 in the unlocking directions, strong locking forces can be obtained. As a result, lowering of the forces for locking of the terminal fittings 10 can be prevented.

The bulb socket 100 according to the first embodiment of the present disclosure incorporates the locking structure 1 of terminal fittings. Therefore, when the terminal containing portions 30 of the socket main body 20 hold and contain the respective terminal fittings 10, since the elastic deformation amounts of the lock projections 15 are reduced, lowering of their resilience can be prevented. Furthermore, since the restriction member 50 restricts elastic deformation of the holding-side lock portions 31 in the unlocking directions, strong locking forces can be obtained. As a result, lowering of the forces for locking of the terminal fittings 10 can be prevented.

The illumination device 200 according to the first embodiment of the present disclosure incorporates the bulb socket 100. Therefore, as in the bulb socket 100, lowering of the forces for locking of the terminal fittings 10 can be prevented.

Furthermore, in the illumination device 200 according to the first embodiment of the present disclosure, since the restriction walls 51 are placed between the holding-side lock portions 31 and the cover lock portions 23 in the unlocking directions of the holding-side lock portions 31, respectively, elastic deformation of the holding-side lock portions 31 in the unlocking directions can be restricted. And the inner wall surfaces 23b of the cover lock portions 23 which are made stronger as a result of their locking on the respective lock counterpart portions 74 of the light leakage prevention cover 70 prevent bending or positional deviation of the restriction walls 51. As a result, the forces for locking of the terminal fittings 10 can be increased further.

### Embodiment 2

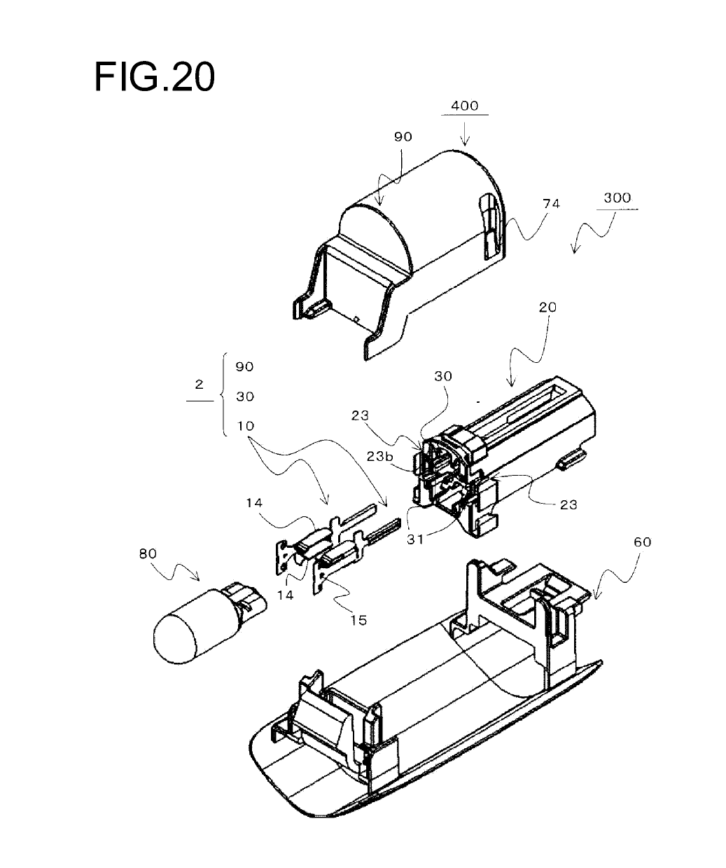

A locking structure 2 of terminal fittings, a bulb socket 300, and an illumination device 400 according to a second embodiment of the present disclosure will be described below with reference to FIG. 20 to FIGS. 24A and 24B.

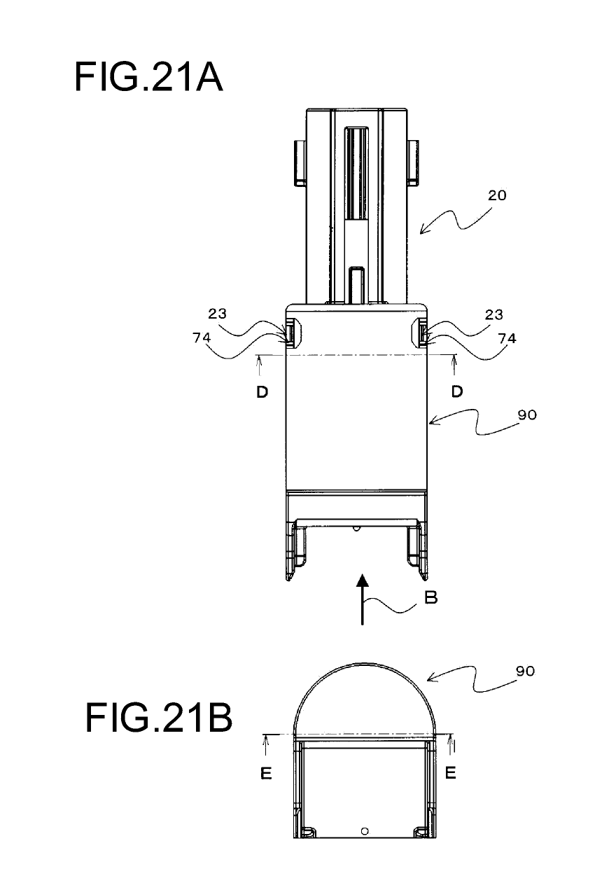

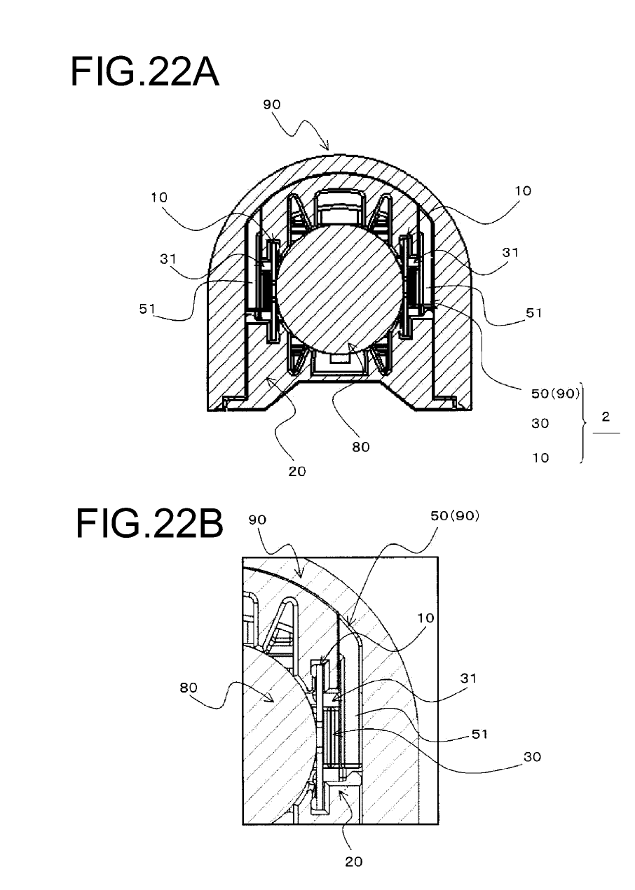

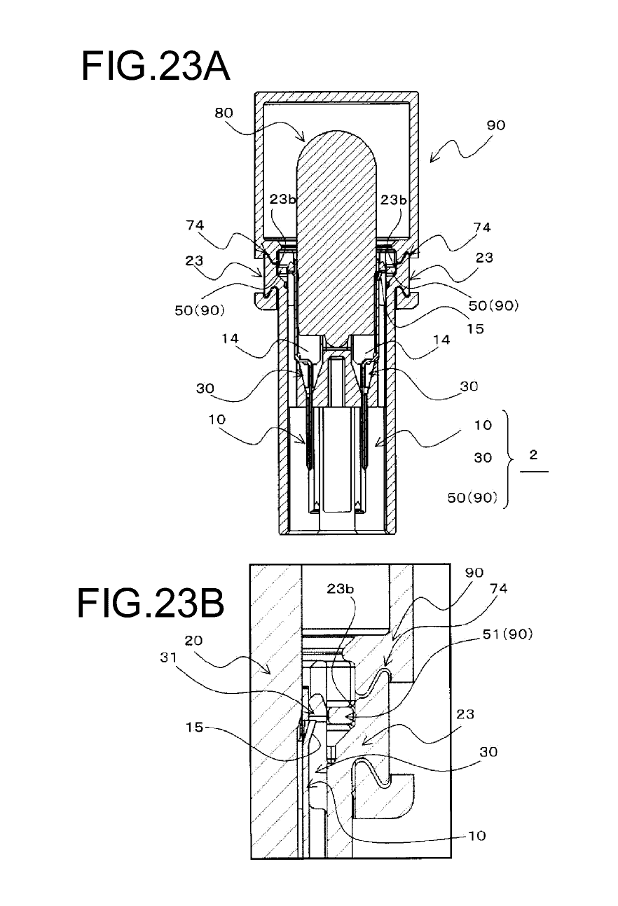

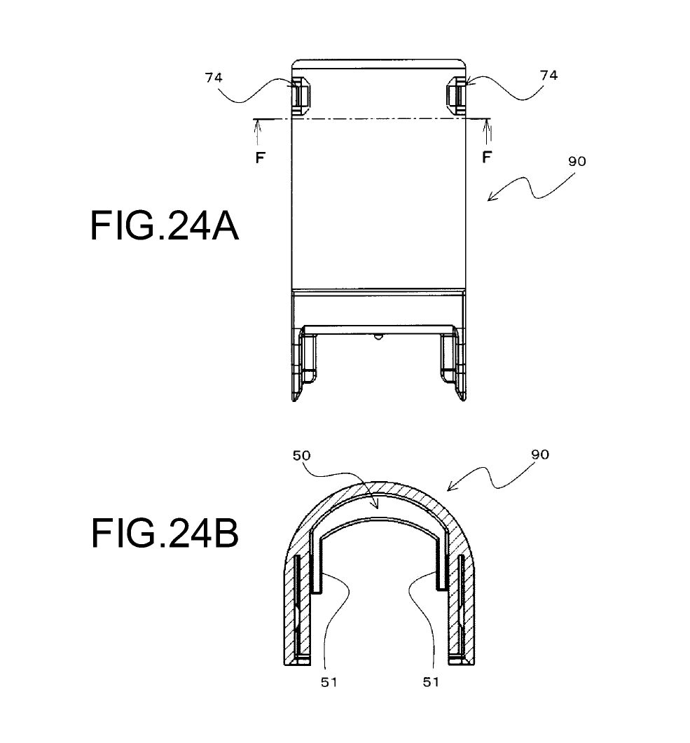

FIG. 20 is an exploded perspective view of the illumination device 400 according to the second embodiment of the present disclosure. FIG. 21A is a front view, as viewed from the side of a light leakage prevention cover 90, of the illumination device 400 shown in FIG. 20 to which a translucent lens 60 has not been attached yet, and FIG. 21 B is a view of the illumination device 400 as view from the direction indicated by arrow B in FIG. 21A. FIG. 22A is a sectional view of the illumination device 400 taken along line D-D in FIG. 21A, and FIG. 22B is an enlarged view of part of FIG. 22A, that is, a restriction wall 51 and its neighborhood. FIG. 23A is a sectional view of the illumination device 400 taken along line E-E in FIG. 21 B, and FIG. 23B is an enlarged view of part of FIG. 23A, that is, a restriction wall 51 and its neighborhood. FIG. 24A is a top view of the light leakage prevention cover 90 shown in FIG. 20, and FIG. 24B is a sectional view of the light leakage prevention cover 90 taken along line F-F in FIG. 24A.

In the locking structure 1 of terminal fittings, the bulb socket 100, and the illumination device 200 according to the first embodiment of the present disclosure, the restriction member 50 and the light leakage prevention cover 70 are separate from each other. In contrast, in the locking structure 2 of terminal fittings, the bulb socket 300, and the illumination device 400 according to the second embodiment of the present disclosure, the restriction member 50 used in the first embodiment is integrated with the light leakage prevention cover 90. The other members etc. are the same as in the first embodiment, and constituent elements having the same ones in the first embodiment will be given the same reference symbols as the latter.

In the locking structure 2 of terminal fittings, the light leakage prevention cover 90 itself has the function of the restriction member 50 used in the first embodiment. When the light leakage prevention cover 90 is attached to the socket main body 20 in which the terminal fittings 10 are inserted, as shown in FIGS. 22A and 22B and FIGS. 23A and 23B each restriction wall 51 is placed between the cover lock portion 23 and the pair of elastic arms 31a.

The pair of elastic arms 31a of each holding-side lock portion 31 are bent outward into the gap space 32 into which the restriction wall 51 is to be inserted later. Therefore, the terminal fittings 10 can move to the lock positions while the elastic deformation amounts of the lock projections 15 are kept small.

The locking structure 2 of terminal fittings, the bulb socket 300, and the illumination device 400 according to the second embodiment of the present disclosure provide the same advantages as the locking structure 1 of terminal fittings, the bulb socket 100, and the illumination device 200 according to the first embodiment of the present disclosure. Furthermore, since the restriction member 50 is integrated with the light leakage prevention cover 90, the number of components of the illumination device 400 is decreased and hence work of assembling it is facilitated.

Although the locking structures 1 and 2 of terminal fittings according to the first and second embodiments of the present disclosure are such as to be incorporated in the bulb sockets 100 and 300 and the illumination devices 200 and 400, respectively, the present disclosure is not limited to such a case. The present disclosure may also be applied to locking structures of a terminal fitting(s) to be incorporated in other components or devices such as connectors.

Although in the locking structures 1 and 2 of terminal fittings according to the first and second embodiments of the present disclosure each lock projection 15 is a nail-shaped projection formed by cutting and erecting a portion of the extension portion 12 and each holding-side lock portion 31 has the pair of elastic arms 31a, the present disclosure is not limited to such a case. It suffices that each lock projection 15 be such as to recover elastically at the lock position of the corresponding holding-side lock portion 31 of the socket main body 20, and that each holding-side lock portion 31 be provided for locking of the corresponding lock projection 15 so as to be able to be deformed elastically in such a direction as to reduce the elastic deformation amount of the lock projection 15 being moved toward the lock position.

Although in the locking structures 1 and 2 of terminal fittings according to the first and second embodiments of the present disclosure each restriction wall 51 is placed between the corresponding cover lock portion 23 and pair of elastic arms 31a, the present disclosure is not limited to such a case. It suffices that each restriction wall 51 be provided so as to restrict elastic deformation of the corresponding holding-side lock portion 31 in the unlocking direction. That is, it suffices that each restriction wall 51 be located outside the corresponding holding-side lock portion 31 in the unlocking direction; the inner wall surface 23b of each cover lock portion 23 need not always be located outside the corresponding restriction wall 51.

Although the present disclosure made by the inventors has been described above in a specific manner using the embodiments of the present disclosure, the present disclosure is not limited to the above embodiments and various modifications are possible without departing from the spirit and scope of the present disclosure.

The present application is based on Japanese Patent Application No. 2013-255865 filed on Dec. 11, 2013, the contents of which are incorporated herein by reference.

What is claimed is:

1. A locking structure of a terminal fitting, comprising:
a terminal fitting;
a terminal containing portion that holds and contains the terminal fitting therein; and
a restriction member that is separate from and is attached to the terminal containing portion,
wherein a lock projection of the terminal fitting is locked on a holding-side lock portion of the terminal containing portion as a result of elastic restoration of the lock projection at a lock position of the holding-side lock portion;
wherein the holding-side lock portion is provided so as to be deformed elastically in such a direction as to reduce an elastic deformation amount of the lock projection being moved toward the lock position for the elastic restoration; and
wherein the restriction member has a restriction wall which restricts elastic deformation of the holding-side lock portion in an unlocking direction in which the lock with the lock projection is released.

2. A bulb socket for supplying power to a bulb as a light source, comprising:
the locking structure of the terminal fitting according to claim 1,
wherein the terminal fitting has a terminal portion which is connected to the bulb; and
wherein the terminal containing portion is provided in a socket main body of the bulb socket.

3. An illumination device comprising:
a bulb as a light source;
a translucent lens for transmitting, to outside the illumination device, light emitted from the bulb;
a light leakage prevention cover that prevents leakage of light through a portion other than the translucent lens; and
the bulb socket according to claim 2.

4. The illumination device according to claim 3, wherein the socket main body has a cover lock portion which is locked on the light leakage prevention cover;
wherein the light leakage prevention cover has a lock counterpart portion on which the cover lock portion is locked so as to be supported by the cover lock portion; and
wherein the restriction member is attached to the terminal containing portion so that an inner wall surface of the cover lock portion is located outside the restriction wall in the unlocking direction of the holding-side lock portion.

5. The illumination device according to claim 3, wherein the restriction member is integrally formed on the light leakage prevention cover.
